(19) United States
(12) Patent Application Publication
(10) Pub. No.: US 2019/0063353 A1
(43) Pub. Date: Feb. 28, 2019

(54) SYSTEMS AND METHODS TO CONTROL ENGINE FUEL DELIVERY

(71) Applicant: GM GLOBAL TECHNOLOGY OPERATIONS LLC, Detroit, MI (US)

(72) Inventors: Gennaro MERLINO, Turin (IT); Giuseppe CONTE, Torino (IT); Roberto ROMANATO, Settimo Torinese (TO) (IT)

(73) Assignee: GM GLOBAL TECHNOLOGY OPERATIONS LLC, Detroit, MI (US)

(21) Appl. No.: 15/682,621

(22) Filed: Aug. 22, 2017

(51) Int. Cl. F02D 41/14

(52) U.S. Cl. CPC F02D 41/1406; F02D 2041/1433; F02D 2200/04; F02D 2200/1006; F02D 2200/06; F02D 2200/1002

(57) ABSTRACT

Methods and systems are provided for controlling a fuel injector included in a fuel injection system of an engine of a vehicle. A method includes receiving vehicle sensor data that is indicative of air measurement data and engine sensor measurement data. A combustion model is used to estimate, through an iterative approach, a total fuel amount for satisfying a torque request and to estimate start of injection degree based upon the received vehicle sensor data. The estimated total fuel amount and the start of injection degree are outputted for controlling the fuel injector.

### TECHNICAL FIELD

The present disclosure generally relates to engine control, and more particularly relates to engine fuel control delivery.

### BACKGROUND

This section provides background information related to the present disclosure which is not necessarily prior art.

Automotive engine control approaches use different approaches for controlling fuel delivery. For example, an automotive engine control approach can use torque-to-fuel maps. The maps provide a certain degree of combustion efficiency when determining a fuel amount to satisfy a certain driver torque request. The maps, however, are calibrated in steady state and with nominal components, so that in the case of transient conditions, the maps may not be aligned with a master calibration. This results in error on fuel delivery. Additionally, the maps need to be recalibrated when the combustion situation has changed.

Accordingly, it is desirable to provide efficiently a fuel estimation. In addition, it is desirable to avoid recalibration of torque-to-fuel after a new calibration milestone. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for controlling a fuel injector included in a fuel injection system of an engine of a vehicle. In one embodiment, a method includes receiving vehicle sensor data that is indicative of air measurement data and engine sensor measurement data. A combustion model is used to estimate, through an iterative approach, a total fuel amount for satisfying a torque request and to estimate start of injection degree based upon the received vehicle sensor data. An iteration in the iterative approach includes determining an injected fuel amount. The iterative approach includes using the combustion model with the injected fuel amount that was determined in a previous iteration. The estimated total fuel amount and the start of injection degree are outputted for controlling the fuel injector.

The method includes that iterations involving the combustion model in the iterative approach cease upon satisfying a brake mean effective pressure error threshold.

The method includes that the estimated total fuel amount is a main fuel quantity amount needed to reach a driver brake mean effective pressure torque request.

The method includes that the iterative approach is used with the combustion model in order to reach a target associated with the torque request and to satisfy a MFB50-based target.

The method includes that the driver brake mean effective pressure torque request establishes the MFB50-based target.

The method includes that the combustion model includes a heat model for determining heat release estimations.

The method includes that the combustion model includes a friction model that is representative of mechanical, pumping and heat losses.

The method includes that the combustion model receives as inputs engine air system measurements, pressure measurements, and temperature measurements.

The method includes that the combustion model includes an accumulated fuel mass determination that is based on an estimated rate of released chemical energy is proportional to energy associated with a fuel quantity available for combustion.

The method includes that the combustion model provides estimation of combustion efficiency in transient conditions and is used with part-to-part variations.

In one embodiment, a fuel injection system includes a fuel injector and an electronic control unit for controlling the fuel injector. The electronic control unit is configured to receive vehicle sensor data that is indicative of air measurement data and engine sensor measurement data. A combustion model is used to estimate, through an iterative approach, a total fuel amount for satisfying a torque request and to estimate start of injection degree based upon the received vehicle sensor data. An iteration in the iterative approach includes determining an injected fuel amount. The iterative approach includes using the combustion model with the injected fuel amount that was determined in a previous iteration. The estimated total fuel amount and the start of injection degree are outputted for controlling the fuel injector.

The system includes that iterations involving the combustion model in the iterative approach cease upon satisfying a brake mean effective pressure error threshold.

The system includes that the estimated total fuel amount is a main fuel quantity amount needed to reach a driver brake mean effective pressure torque request.

The system includes that the iterative approach is used with the combustion model in order to reach a target associated with the torque request and to satisfy a MFB50-based target.

The system includes that the driver brake mean effective pressure torque request establishes the MFB50-based target.

The system includes that the combustion model includes a heat release model for determining heat release estimations.

The system includes that the combustion model includes a friction model that is representative of mechanical, pumping and heat losses.

The system includes that the combustion model receives as inputs engine air system measurements, pressure measurements, and temperature measurements.

The system includes that the combustion model includes an accumulated fuel mass determination that is based on an estimated rate of released chemical energy is proportional to energy associated with a fuel quantity available for combustion; wherein the combustion model provides estimation of combustion efficiency in transient conditions and is used with part-to-part variations.

In one embodiment, a non-transitory computer readable medium stores a program, which when executed on an electronic control unit which controls a fuel injector of a vehicle, is configured to receive vehicle sensor data that is indicative of air measurement data and engine sensor measurement data. A combustion model is used to estimate, through an iterative approach, a total fuel amount for satisfying a torque request and to estimate start of injection degree based upon the received vehicle sensor data. An iteration in the iterative approach includes determining an injected fuel amount. The iterative approach includes using the combustion model with the injected fuel amount that was determined in a previous iteration. The estimated total fuel amount and the start of injection degree are outputted for controlling the fuel injector.

### DESCRIPTION OF THE DRAWINGS

The exemplary embodiments will hereinafter be described in conjunction with the following drawing figures, wherein like numerals denote like elements.

FIG. 1 schematically shows an automotive system according to an embodiment of the present disclosure;

FIG. 2 is the section A-A of an internal combustion engine belonging to the automotive system of FIG. 1;

FIG. 3 is block diagram depicting a model-based control for optimizing engine control throughput;

FIG. 4 is a block diagram depicting operation of a combustion model;

FIG. 5 represents mathematical equations for use in a combustion model;

FIG. 6 is a graph depicting chemical heat release plots; and

FIG. 7 is a block diagram depicting use of a model-based approach for engine control.

### DETAILED DESCRIPTION

The following detailed description is merely exemplary in nature and is not intended to limit the invention disclosed herein or the application and uses of the invention disclosed herein. Furthermore, there is no intention to be bound by any principle or theory, whether expressed or implied, presented in the preceding technical field, background, summary or the following detailed description, unless explicitly recited as claimed subject matter.

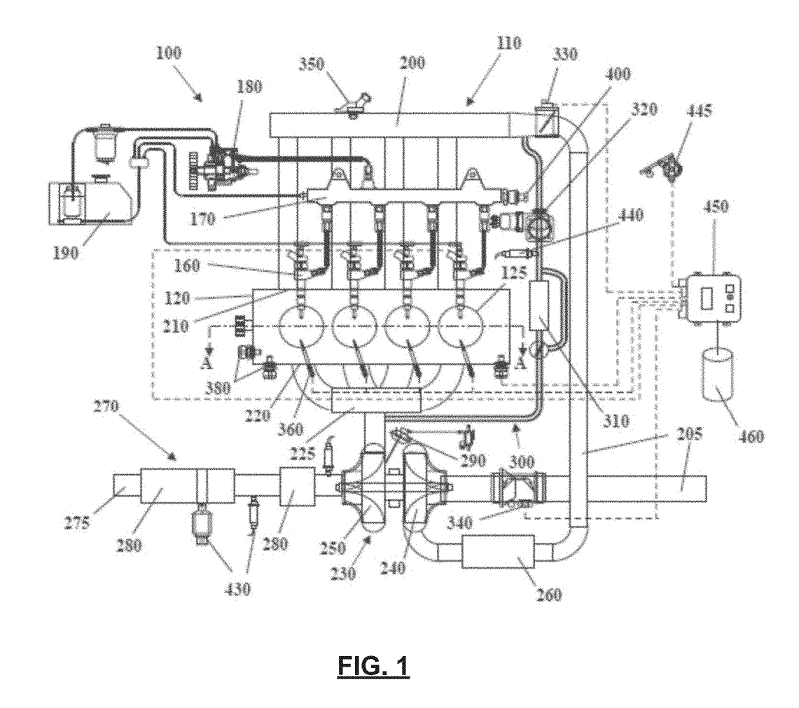

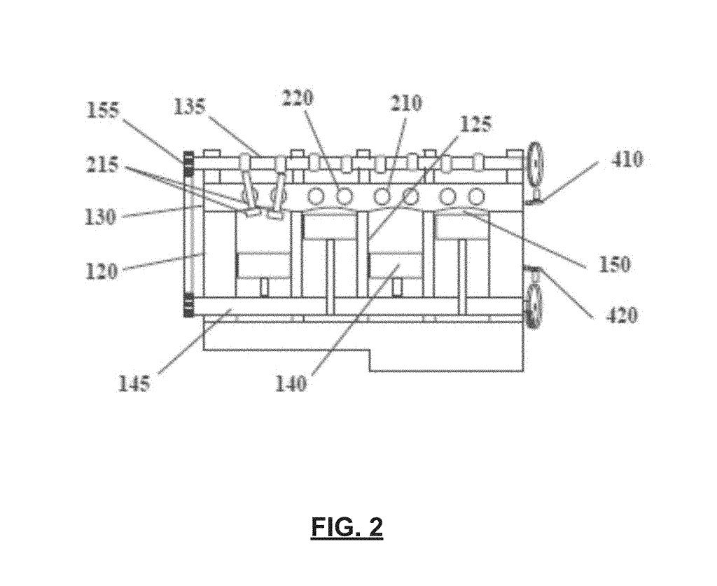

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an aftertreatment system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The aftertreatment system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOₓ traps, hydrocarbon adsorbers, selective catalytic reduction (SCR) systems, and particulate filters, such as a Selective Catalytic Reduction on Filter (SCRF) 500.

The SCRF 500 may be associated with a temperature sensor upstream of the SCRF 500 and temperature sensor downstream of the SCRF 560.

Other embodiments may include a high pressure exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carry out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a Wi-Fi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an ASIC, a CD or the like.

Instead of an ECU 450, the automotive system 100 may have a different type of processor to provide the electronic logic, e.g. an embedded controller, an onboard computer, or any processing module that might be deployed in the vehicle.

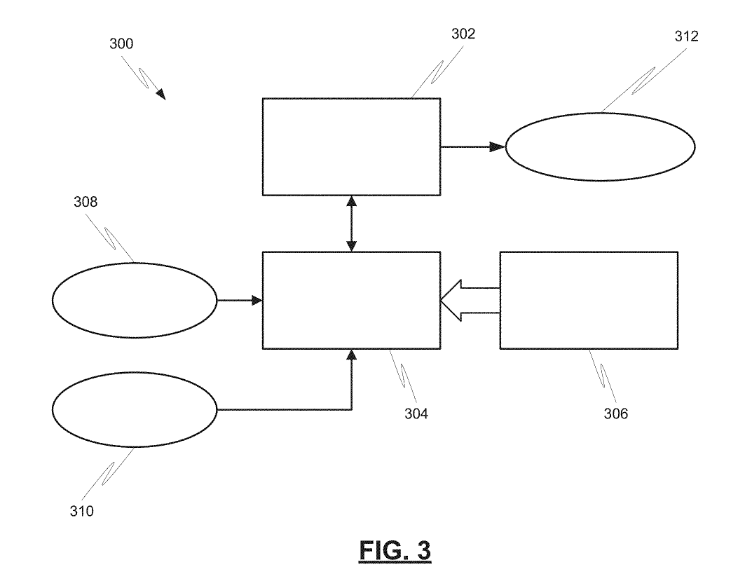

FIG. 3 depicts at 300 a system that uses model-based control for optimizing ECU throughput and improve torque accuracy in transient conditions for drivability purposes. The system 300 uses a combustion model 304 to estimate, through an iterative approach 306, a total fuel amount for satisfying a torque request at 308. Each iteration in the iterative approach determines a new injected fuel amount. The estimated total fuel amount is outputted for controlling fuel injection 312.

More specifically, engine fuel delivery control 302 is based on a physical combustion model 304 which uses the iterative approach 306 to reach targets based on the amount of requested torque 308 and MFB50 310. The input MFB50 310 indicates the angle where 50% of fuel mass is burnt. This angle is used so that the system 300 can properly adjust injection in order to produce the desired combustion.

The system 300 is a model-based approach in that it is a physical model working both in steady and dynamic conditions. Based on engine state conditions (e.g., number of injection pulses, distance between pulses, air actuated, EGR rate actuated, and other sensor measurements), the system 300 can estimate the total amount of torque forming fuel in order to satisfy a BMEP (brake mean effective pressure) torque request. Because the combustion model is developed as a physical model, the system 300 can exhibit accuracy both in steady and dynamic conditions.

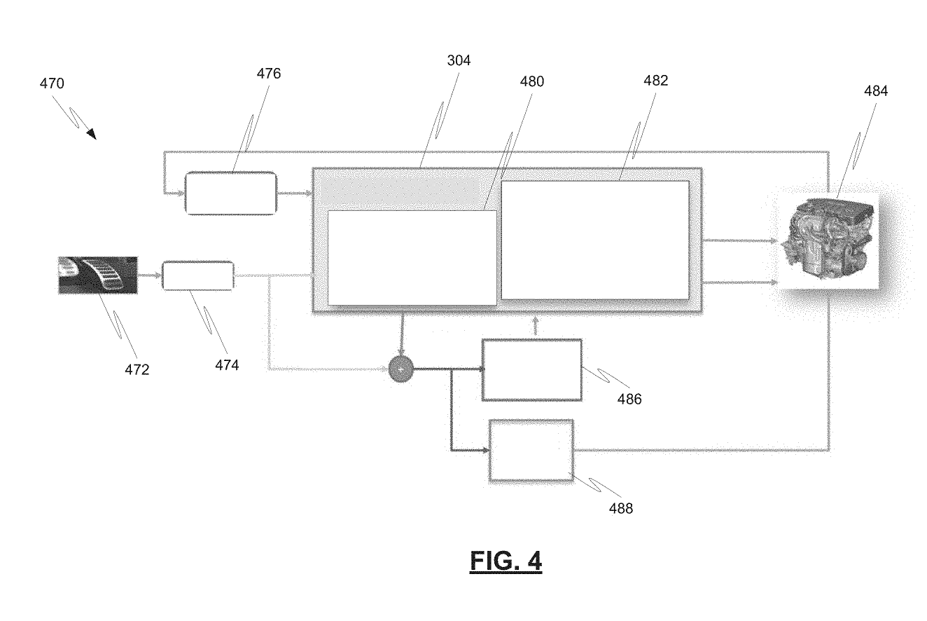

FIG. 4 depicts at 470 an operational environment within which the combustion model 304 can operate. In the operational environment 470, a BMEP target is used as a model input. BMEP is brake mean effective pressure associated with the brake pedal 472 through which the driver is requiring a torque request after processing by the coordinate torque control 474. The BMEP request is provided as an input into the combustion model 304.

The combustion model 304 can further receive as input 476 air measurements/estimations (e.g., EGR (exhaust gas recirculation) quantity, intake and exhaust pressure and temperature, oxygen concentration, etc.) and fuel parameters (e.g., fuel pressure, injection pattern such as number, size and angle position of small pulses, start of injection of main pulse, etc.). In view of this, the control system achieves torque accuracy in transient conditions. A starting value of the injected fuel quantity is also assumed for the combustion model 304. The system also can include as inputs system set points 488 for indicating torque as Prail, pilot quantity, etc.

An iterative procedure is applied to the combustion model 304 using the inputs upon friction and heat release models 480 and 482. The friction and heat release models 480 and 482 allow for an increased combustion efficiency. The iterative procedure continues until the total fuel amount is obtained that is capable to assure a BMEP error below a certain calibratable threshold. During the iterations, the values of the injected quantity are scaled according to the ratio between the target and actual values of BMEP until convergence is achieved. In addition to providing the total fuel amount for controlling fuel delivery for the engine 484, the combustion model 304 also provides the start of main injection (SOI) (as expressed in degrees) as an output in order to reach the MFB50 target.

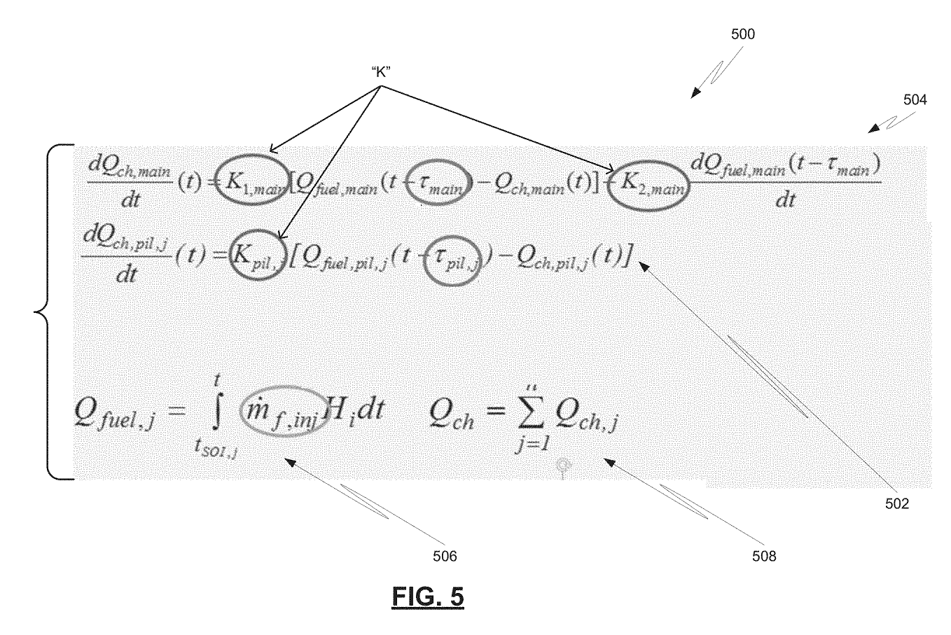

FIG. 5 depicts combustion model equations at 500. The combustion model 304 provides an estimation of the chemical energy release (Q_{ch}). The chemical energy release has been simulated on the basis of an accumulated fuel mass approach. The accumulated fuel mass approach assumes that, at any time instant, the rate of chemical energy released by the fuel is proportional to the energy associated with the in-cylinder accumulated fuel mass. Such an energy can be calculated at time instant “t” as the difference between the chemical energy of the injected fuel mass and the released chemical energy. This approach leads to generating the pilot injections, for which the chemical energy release rate is shown at 502 where: K_{pil,j} and τ_{pil,j} are model calibration quantities related to the combustion rate and to the ignition delay, respectively; and Q_{fuel,pil,j} is the chemical energy associated with the injected fuel mass.

The chemical energy release of the main pulse (Q_{ch,main}) is calculated as shown at 504 where K_{1,main} and K_{2,main} are combustion rate coefficients, and τₘₐᵢₙ is an ignition delay coefficient. For each injection pulse j, the chemical energy (Q_{fuel}) associated with the injected fuel quantity is defined at 506 where: t_{SOI,j} is the start of the injection time; Hᵢ is the lower heating value of the fuel; and \dot{m}_{f,inj} is the fuel mass injection rate. The total chemical energy (Q_{ch}) release is given by the sum of the contributions of all the injection pulses as shown at 508.

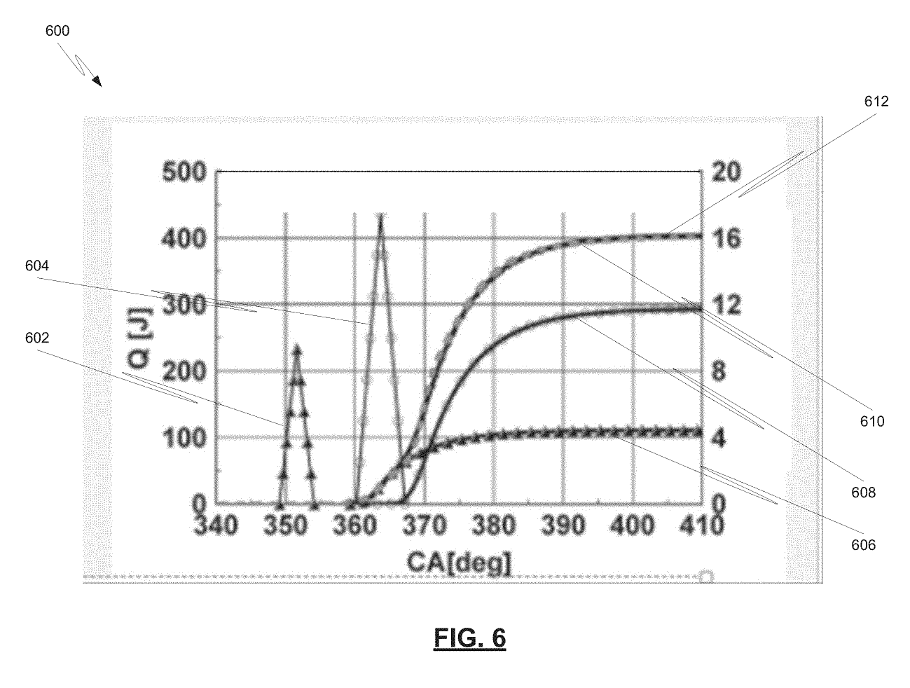

FIG. 6 depicts a graph 600 illustrating chemical heat release (Q) versus injection rate and crank angle (CA). The graph 600 shows the injection rate (pilot) at 602, injection rate (main) at 604, Q_{ch,pilot} at 606, Q_{ch,main} at 608, Q_{ch} (predicted) at 610, and Q_{ch} (experimental) at 612. The mathematical approach shown in FIG. 5 is validated based upon the plot of Q_{ch} (predicted) at 610 approximating the plot of Q_{ch} (experimental) at 612.

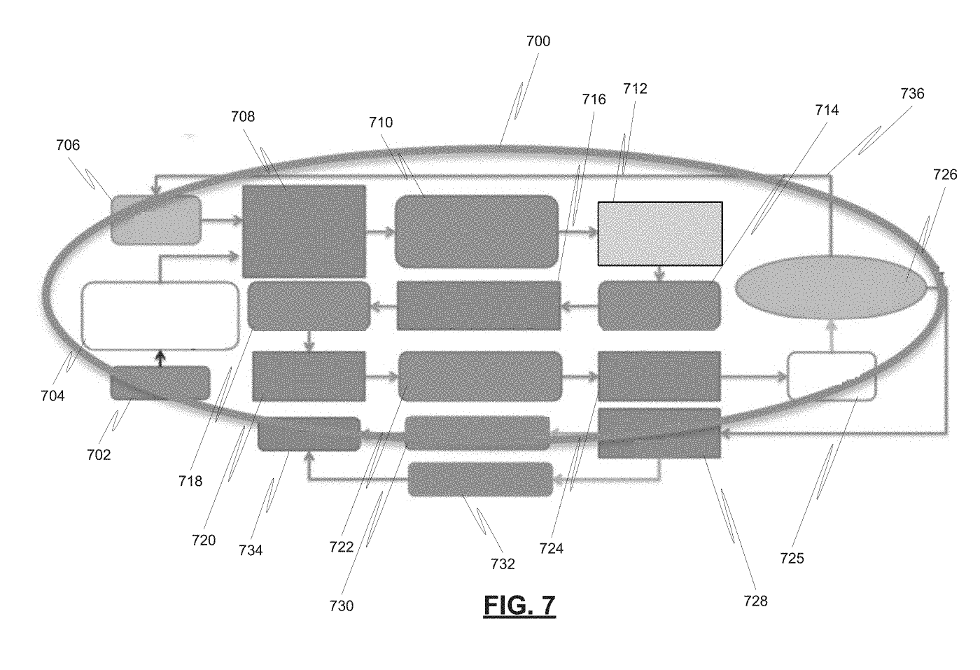

FIG. 7 depicts a process at 700 for generating the output values for controlling fuel injection in an iterative approach. Overall, the process 700 iterates until a BMEP value is found that satisfies pre-selected criteria. The example of FIG. 4 shows that the process 700 performs the BMEP criteria check at 726. If the BMEP criteria is not satisfied, then the process 700 iterates back at 736 to perform additional model-based analysis using an updated injected fuel volume quantity 706. If the BMEP criteria is satisfied, then the process 700 performs emission analysis at 728 before terminating at 734.

More specifically, the process 700 uses multiple models to generate the fuel injection control values, such as an EGR model at 708, a gross heat combustion model at 712, etc. Start block 702 indicates that the process 700 begins by performing steady-state correlations and EGR model analysis at 708. Process 708 uses inputs 704 and assumes an initial value for the injected fuel quantity (q_{f,inj}). The inputs 704 include: the BMEP target value, engine rotational speed (n), electric start of injection (SOI_{main/pil}), injection pressure (p_{f}), injected fuel volume quantity of the pilot injection (qₚᵢₗ), EGR valve opening signal (u_{EGR}), throttle valve opening signal (uₜₕ), and cooler by-pass flag (f_{CPB}).

Process 708 uses steady-state correlations and pre-specified look-up tables to generate outputs 710 for the gross heat combustion model 712. The outputs 710 include: intake manifold pressure (pᵢₙₜ), intake manifold temperature (Tᵢₙₜ), exhaust manifold pressure (pₑₓₕ) exhaust manifold temperature (Tₑₓₕ), trapped mass (mₜᵣₐₚ), EGR rate (Xᵣ), and intake charge oxygen concentration (O₂). The gross heat combustion model 712 provides an estimate for the gross chemical heat release (Q_{ch}) 714 for use in a heat transfer model 716 using the approach described with respect to FIG. 5.

The heat transfer model 716 uses the gross heat release 714 and fuel evaporation variables to determine the net heat release (Qₙₑₜ) 718. A pressure model 720 uses the net heat release 718 to calculate the in-cylinder pressure traces and related combustion parameters IMEP (indicated mean effective pressure) and PFP (peak firing pressure) for use in a friction model 724. The friction model 724 allows FMEP (friction mean effective pressure) to be estimated, in order to evaluate BMEP 725 at process 726. In this example, the friction model 724 uses the conventional Chenn-Flynn approach to predict FMEP on the basis of the engine speed and PFP. The simulation of FMEP allows BMEP 725 to be evaluated starting from IMEP.

Process 726 examines whether the difference between the calculated BMEP value 725 and the BMEP_{target} value received at 704 is within a certain error amount. If it is not, then processing iterates back as shown at 736 with the most recently calculated injected fuel quantity (q_{f,inj}) being used as input to process 706. During the iteration process, the values of the injected quantity are scaled iteratively according to the ratio between the target and actual values of BMEP, until convergence is achieved. In this example, an average number of three iterations may be sufficient to achieve convergence, assuming a difference of 0.1 bar between the predicted and target values of BMEP as the convergence criterion.

If the difference between the calculated BMEP value 725 and the BMEP_{target} value received at 704 is within a certain error amount, then an emission model 728 is used to estimate NOₓ emission 732 and soot emission 730. The emission model 728 can use NOx and soot emissions that have been simulated on the basis of semi-empirical correlations that take into account in-cylinder thermodynamic properties, the chemical energy release, and main engine parameters. After the emissions 730 and 732 have been calculated, the model-based analysis completes at end block 734 whereupon the results of are used for fuel injection control.

While at least one exemplary embodiment has been presented in the foregoing detailed description, it should be appreciated that a vast number of variations exist. For example, the systems and methods disclosed herein are model-based approach in that it is a physical model working both in steady and dynamic conditions. Because the combustion model is developed as a physical model, a system can exhibit accuracy both in steady and dynamic conditions. This further results in advantages in torque release (e.g. drivability). Moreover, the model-based control reduces the number of torque-to-fuel maps because the calibrations in the model-based approach are based on physical equations. This leads to a reduction in calibration effort. ECU memory occupation is improved because the number of maps is reduced.

It should also be appreciated that the exemplary embodiment or exemplary embodiments are only examples, and are not intended to limit the scope, applicability, or configuration of the disclosure in any way. Rather, the foregoing detailed description will provide those of ordinary skill in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a fuel injector included in a fuel injection system of an engine of a vehicle, the method comprising:
receiving vehicle sensor data that is indicative of air measurement data and engine sensor measurement data;
using a combustion model to estimate, through an iterative approach, a total fuel amount for satisfying a torque request and to estimate start of injection degree based upon the received vehicle sensor data;
wherein an iteration in the iterative approach includes determining an injected fuel amount;
wherein the iterative approach includes using the combustion model with the injected fuel amount that was determined in a previous iteration; and
outputting the estimated total fuel amount and the start of injection degree for controlling the fuel injector.

2. The method of claim 1, wherein iterations involving the combustion model in the iterative approach cease upon satisfying a brake mean effective pressure error threshold.

3. The method of claim 1, wherein the estimated total fuel amount is a main fuel quantity amount needed to reach a driver brake mean effective pressure torque request.

4. The method of claim 3, wherein the iterative approach is used with the combustion model in order to reach a target associated with the torque request and to satisfy a MFB50-based target.

5. The method of claim 4, wherein the driver brake mean effective pressure torque request establishes the MFB50-based target.

6. The method of claim 1, wherein the combustion model includes a heat model for determining heat release estimations.

7. The method of claim 1, wherein the combustion model includes a friction model that is representative of mechanical, pumping and heat losses.

8. The method of claim 1, wherein the combustion model receives as inputs engine air system measurements, pressure measurements, and temperature measurements.

9. The method of claim 1, wherein the combustion model includes an accumulated fuel mass determination that is based on an estimated rate of released chemical energy is proportional to energy associated with a fuel quantity available for combustion.

10. The method of claim 1, wherein the combustion model provides estimation of combustion efficiency in transient conditions and is used with part-to-part variations.

11. A fuel injection system, comprising:
a fuel injector; and
an electronic control unit for controlling the fuel injector and is configured to:
receive vehicle sensor data that is indicative of air measurement data and engine sensor measurement data;
use a combustion model to estimate, through an iterative approach, a total fuel amount for satisfying a torque request and to estimate start of injection degree based upon the received vehicle sensor data;
wherein an iteration in the iterative approach includes determining an injected fuel amount;
wherein the iterative approach includes using the combustion model with the injected fuel amount that was determined in a previous iteration; and
output the estimated total fuel amount and the start of injection degree for controlling the fuel injector.

12. The system of claim 11, wherein iterations involving the combustion model in the iterative approach cease upon satisfying a brake mean effective pressure error threshold.

13. The system of claim 11, wherein the estimated total fuel amount is a main fuel quantity amount needed to reach a driver brake mean effective pressure torque request.

14. The system of claim 13, wherein the iterative approach is used with the combustion model in order to reach a target associated with the torque request and to satisfy a MFB50-based target.

15. The system of claim 14, wherein the driver brake mean effective pressure torque request establishes the MFB50-based target.

16. The system of claim 11, wherein the combustion model includes a heat release model for determining heat release estimations.

17. The system of claim 11, wherein the combustion model includes a friction model that is representative of mechanical, pumping and heat losses.

18. The system of claim 11, wherein the combustion model receives as inputs engine air system measurements, pressure measurements, and temperature measurements.

19. The system of claim 11, wherein the combustion model includes an accumulated fuel mass determination that is based on an estimated rate of released chemical energy is proportional to energy associated with a fuel quantity available for combustion; wherein the combustion model provides estimation of combustion efficiency in transient conditions and is used with part-to-part variations.

20. A non-transitory computer readable medium storing a program, which when executed on an electronic control unit which controls a fuel injector of a vehicle, is configured to:
receive vehicle sensor data that is indicative of air measurement data and engine sensor measurement data;
use a combustion model to estimate, through an iterative approach, a total fuel amount for satisfying a torque request and to estimate start of injection degree based upon the received vehicle sensor data;
wherein an iteration in the iterative approach includes determining an injected fuel amount;
wherein the iterative approach includes using the combustion model with the injected fuel amount that was determined in a previous iteration; and
output the estimated total fuel amount and the start of injection degree for controlling the fuel injector.
